(19) United States
(12) Patent Application Publication
(10) Pub. No.: US 2009/0070446 A1
(43) Pub. Date: Mar. 12, 2009

(54) SYSTEM AND METHOD FOR SECURING OF DOCUMENT PROCESSING DEVICES IN ACCORDANCE WITH USE PATTERNS

(76) Inventors: Amir SHAHINDOUST, Laguna Niguel, CA (US); Sameer Yami, Irvine, CA (US); Peter Hn Tran, Garden Grove, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,135

(22) Filed: Sep. 6, 2007

(51) Int. Cl. G06F 15/16; G06F 17/30

(52) U.S. Cl. 709/223; 707/102; 707/E17.009

(57) ABSTRACT

The subject application is directed to a system and method for securing of document processing devices in accordance with use patterns. Operational data is first received associated with the historic operation of an associated document processing device is first received. Next, feature data corresponding to the available capabilities of the associated document processing device is received. Utilization data is then generated according to the received operational data and the feature data, which includes data representing underutilized capabilities of the associated document processing device. An electronic document is then output inclusive of the generated utilization data.

### BACKGROUND OF THE INVENTION

The subject application is directed generally to security in office machinery, and is particularly suited to minimizing security risks in document processing devices by elimination of unneeded or less used features associated with a particular user environment.

Document processing devices, such as copiers, printers, scanners, or facsimile machines, as well as multifunction peripherals having more than one capability, are widely used in office environments. Due to costs associated with the purchase and maintenance of such devices, they are frequently shared among multiple users.

Since shared peripherals are accessible to many users, there is an inherent risk that users can access secure information that is passed through or stored on a document processing device. This risk is amplified when a device is shared over a network, particularly if that network is externally accessible, such as having a data path to the global Internet.

Each feature associated with a document processing device adds additional risks and possible security breach points.

### SUMMARY OF THE INVENTION

In accordance with one embodiment of the subject application, there is provided a system and method for providing security in office machinery.

Further, in accordance with one embodiment of the subject application, there is provided a system and method for minimizing security risks in document processing devices by elimination of unneeded or less used features associated with a particular user environment.

Still further, in accordance with one embodiment of the subject application, there is provided a system for securing of document processing devices in accordance with use patterns. The system comprises means adapted for receiving operational data associated with historic operation of an associated document processing device and means adapted for receiving feature data corresponding to available capabilities of the associated document processing device. The system also comprises generator means adapted for generating utilization data in accordance with received operational data and received feature data, wherein the utilization data includes data representative of underutilized capabilities of the document processing device. The system further includes output means adapted for outputting an electronic document inclusive of generated utilization data.

In one embodiment of the subject application, the system further includes means adapted for receiving the operational data inclusive of identification data corresponding to identities of each of a plurality of users of the document processing device, which identification data is associated with operational data corresponding to a respective user. In such embodiment, utilization data is generated in accordance with a comparison of operational data and feature data.

In another embodiment of the subject application, operational data includes data corresponding to resource utilization of the associated document processing device and wherein feature data includes data corresponding to available resources of the document processing device, such that the generator means further includes means adapted for generating utilization data in accordance with comparison thereof.

In yet another embodiment of the subject application, the system also comprises means adapted for receiving adjustment data representative of a reallocation of resources of the associated document processing device in accordance with generated utilization data.

In a further embodiment of the subject application, the system further comprises means adapted for selectively disabling capabilities of the associated document processing device in accordance with generated utilization data.

In another embodiment of the subject application, the output means includes means adapted for communicating the electronic document to an associated administrator.

Still further, in accordance with one embodiment of the subject application, there is provided a method for securing of document processing devices in accordance with use patterns in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for securing of document processing devices in accordance with use patterns according to one embodiment of the subject application;

FIG. 2 is a block diagram illustrating controller hardware for use in the system for securing of document processing devices in accordance with use patterns according to one embodiment of the subject application;

FIG. 3 is a functional diagram illustrating the controller for use in the system for securing of document processing devices in accordance with use patterns according to one embodiment of the subject application;

FIG. 4 is a flowchart illustrating a method for securing of document processing devices in accordance with use patterns according to one embodiment of the subject application; and

FIG. 5 is a flowchart illustrating a method for securing of document processing devices in accordance with use patterns according to one embodiment of the subject application.

### DETAILED DESCRIPTION OF THE PREFERRED EMBODIMENT

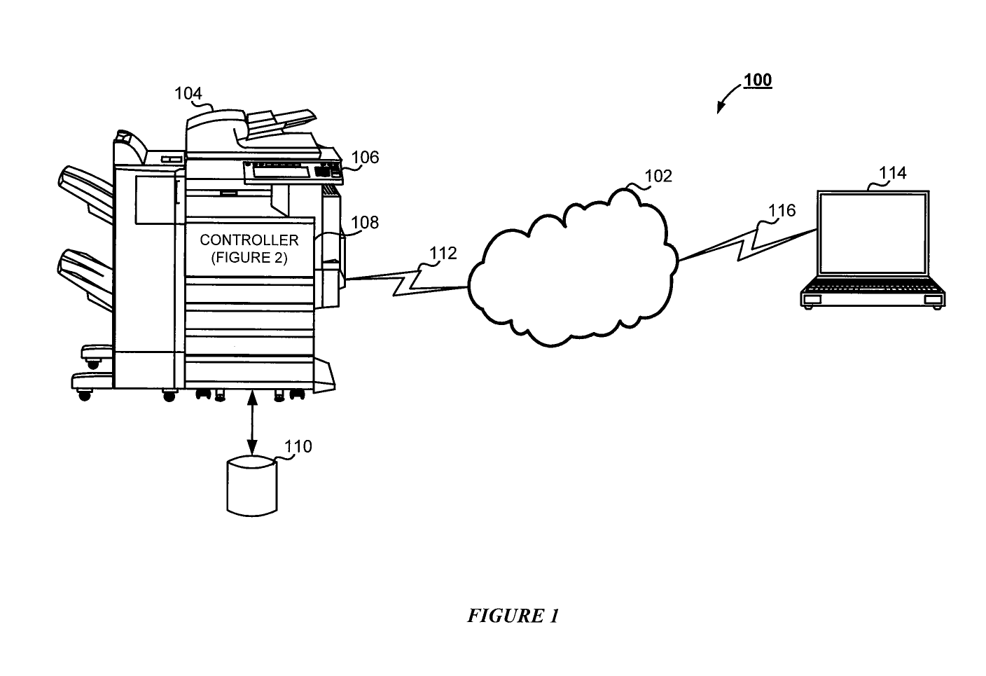

The subject application is directed to a system and method for providing security in office machinery. In particular, the subject application is directed to a system and method for minimizing security risks in document processing devices by elimination of unneeded or less used features associated with a particular user environment. It will become apparent to those skilled in the art that the system and method described herein are suitably adapted to a plurality of varying electronic fields employing remote optimization, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for securing document processing devices in accordance with use patterns according to one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

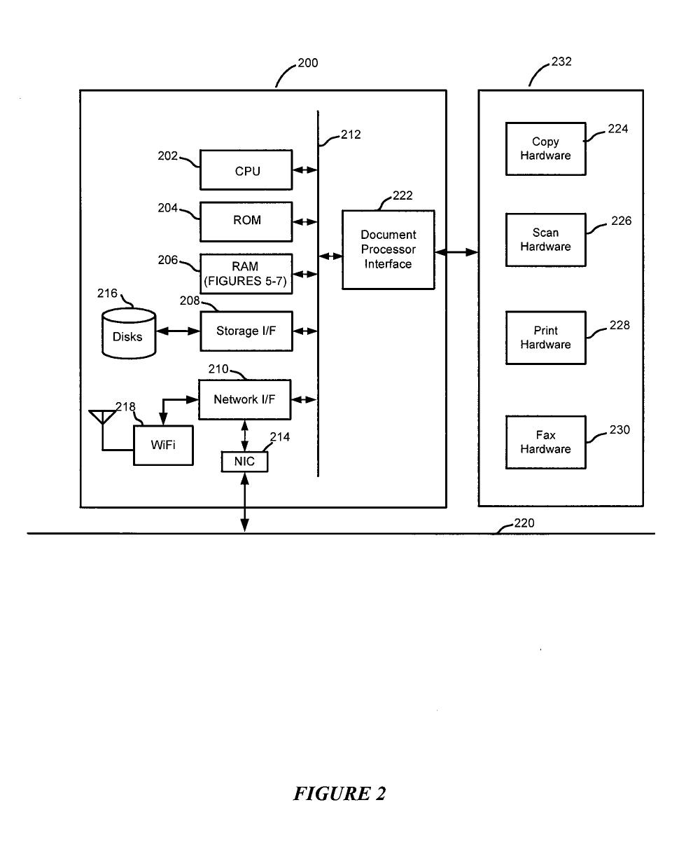

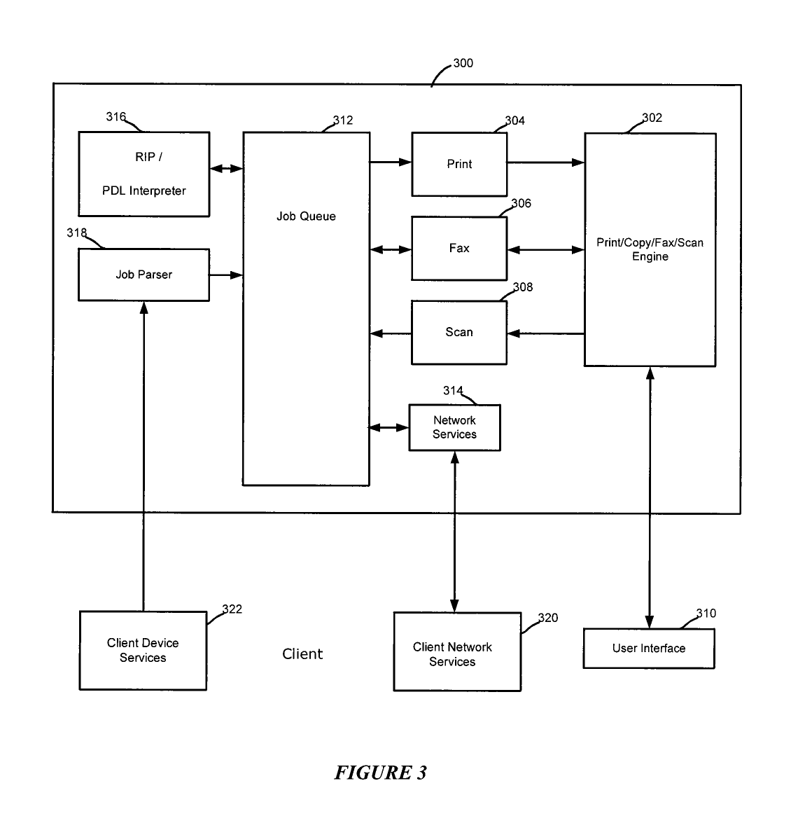

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for securing document processing devices in accordance with use patterns of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store operational data associated with the document processing device 104, feature data, device capability data, document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, operational data associated with the historic operation of an associated document processing device is first received. Next, feature data corresponding to the available capabilities of the associated document processing device is received. In accordance with the received operational data and the feature data, utilization data is generated including data representing underutilized capabilities of the associated document processing device. An electronic document is then output inclusive of the generated utilization data.

In accordance with one example embodiment of the subject application, a monitoring component is first initiated for monitoring operations of the document processing device 104. As will be understood by those skilled in the art, the monitoring component is any hardware, software, or combination thereof, capable of monitoring and recording operations, resource usage, user information, or the like, associated with operations of the document processing device 104. According to one example embodiment of the subject application, the monitoring component is software resident on the controller 108 or other suitable component associated with the document processing device 104. The monitoring component, via the controller 108, continues to monitor operational data and feature data, as will be explained in greater detail below.

The controller 108, in accordance with the monitoring component, then receives operational data associated with the historic operation of the document processing device 104. The controller 108 or other suitable component associated with the document processing device 104 then receives operational data including identification data identifying each of a plurality of users of the document processing device 104. Preferably, the identification data is associated with operational data corresponding to each respective user. The monitoring component associated with the controller 108 then receives operational data representing resource utilization. That is, the controller 108 collects data corresponding to the resources used by the document processing device 104 during the operations thereof. Feature data of the available capabilities of the associated document processing device 104 is then received by the monitoring component associated with the controller 108. Feature data of available resources of the document processing device 104 is also received by the monitoring component via the controller 108. It will be apparent to those skilled in the art that the operational and feature data is capable of being received by the controller 108 in any order, and the listing above is for example purposes only.

The controller 108 then determines whether or not the received data is ready to be reported out to an associated administrator, e.g., the administrator associated with the user device 114. In accordance with one embodiment of the subject application, the administrator, via interaction with the user device 114, directs the monitoring component to generate reports inclusive of the received operational data and the received feature data. The skilled artisan will appreciate that such instruction is capable of including restrictions as to the time, date, document processing device 104 activity, or the like, so as to have minimal impact on the operations of the document processing device 104. Stated another way, the administrator is capable of providing instructions to the controller 108 on when to generate utilization reports to enable the modification of the document processing device 104 for performance improvements. When the controller 108, via operations of the monitoring component, determines that no utilization report is necessitated based upon the administrator provided instructions, the controller 108 returns to monitoring and gathering operational and feature data.

When the controller 108 determines that a report is necessary, the operational data is compared to the feature data so as to generate utilization data. As will be understood by those skilled in the art, the utilization data is generated in accordance with the received operation data and the feature data, and also includes underutilized capability information. That is, the utilization data includes data representative of those capabilities, features, resources, and the like, which are underutilized, based upon the operational data and the feature data. An electronic document is then output by the document processing device 104 to the administrator at the user device 114 via the computer network 102. In accordance with one embodiment of the subject application, the electronic document includes the generated utilization data.

According to one example embodiment of the subject application, the administrator, via the user device 114, receives the electronic document, e.g., a utilization report, and is provided with the opportunity to modify features, capabilities, resource utilization rights, and the like, corresponding to the document processing device 104. In accordance with one embodiment of the subject application, the utilization report includes suggested adjustments to be made to the document processing device 104 to increase the performance thereof. For example and without limitation, the controller 108 or other suitable component associated with the document processing device 104 and implementing the monitoring component, analyzes the received operational data and feature data to determine which features and/or resources are underutilized. These features and/or resources are then noted in the report to the administrator as those features and/or resources whose modification will result in an increase in the performance of document processing operations by the document processing device 104. The changes or modifications selected by the administrator are then communicated from the user device 114 to the document processing device 104 via the computer network 102 in the form of adjustment data. It will be appreciated by those skilled in the art that the use of the user device 114 to communicate adjustment data to the document processing device 104 is for example purposes only, and other means of communication, e.g., portable storage, direct interaction with the user interface 106, or the like, are capable of being used to supply the adjustment data to the document processing device 104.

The adjustment data is then received by the controller 108 or other component associated with the document processing device 104. The controller 108 then analyzes the received adjustment data to determine whether any document processing device capabilities are to be disabled. When one or more capabilities, for example, a scan to electronic mail capability, a text recognition capability, or other underutilized capability, are to be disabled, the controller 108 or other suitable component associated with the document processing device 104 then selectively disables the one or more identified capabilities. Resources associated with the document processing device 104 are then reallocated in accordance with the received adjustment data.

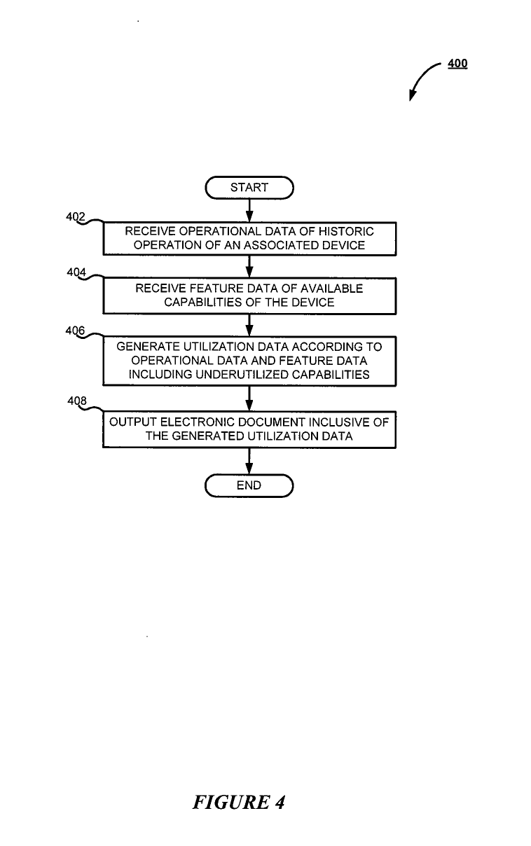

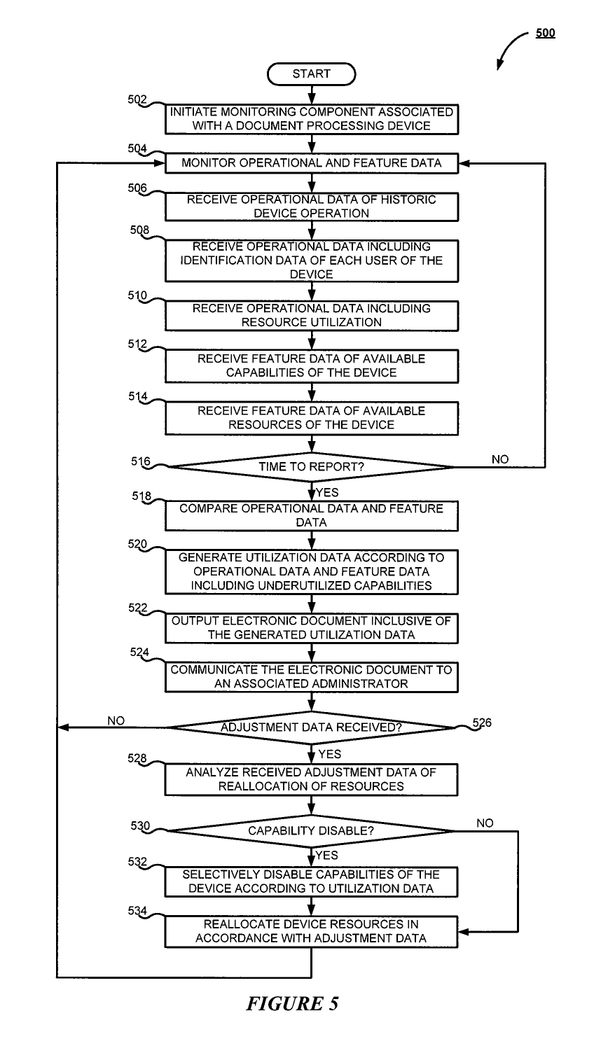

The skilled artisan will appreciate that the subject system 100 and components described above with respect to FIG. 1, FIG. 2, and FIG. 3 will be better understood in conjunction with the methodologies described hereinafter with respect to FIG. 4 and FIG. 5. Turning now to FIG. 4, there is shown a flowchart 400 illustrating a method for securing document processing devices in accordance with use patterns according to one embodiment of the subject application. Beginning at step 402, the controller 108 or other suitable component associated with the document processing device 104 first receives operational data associated with the historic operation of the document processing device 104. Feature data is then received by the controller 108 at step 404 corresponding to the available capabilities of the associated document processing device 104.

The controller 108 or other suitable component associated with the document processing device 104 then generates, at step 406, utilization data in accordance with the received operational data and the feature data. According to one embodiment of the subject application, the utilization data includes data representing underutilized capabilities of the associated document processing device 104. The document processing device 104, via the controller 108, then outputs an electronic document inclusive of the generated utilization data at step 408.

Referring now to FIG. 5, there is shown a flowchart 500 illustrating a method for securing document processing devices in accordance with use patterns according to in accordance with one embodiment of the subject application. The methodology described in FIG. 5 begins at step 502, whereupon a monitoring component, in the form of hardware, software, or a suitable combination thereof, is initiated on the document processing device 104. Preferably, the monitoring component is initiated via operation of the controller 108 or other suitable component of the document processing device 104 and functions to monitor document processing device 104 performance, usage, features, operations, and the like. At step 504, the controller 108, via operation of the monitoring component, monitors operational and feature data associated with the operations and capabilities of the associated document processing device 104.

At step 506, operational data associated with the historic operation of the document processing device 104 is received by the controller 108. Operational data inclusive of identification data corresponding to identities of each a plurality of users of the document processing device 104 is then received by the controller 108 or other suitable component of the document processing device 104 at step 508. Preferably, the identification data is associated with operational data corresponding to a respective user of the document processing device 104. The monitoring component associated with the controller 108 then receives, at step 510, operational data representing resource utilization. The skilled artisan will appreciate that such utilization data corresponds, for example and without limitation, to the resources used by the document processing device 104 during the operations thereof. At step 512, feature data of the available capabilities of the associated document processing device 104 is received by the controller 108. Feature data corresponding to the available resources of the document processing device 104 is then received at step 514 by the monitoring component via the controller 108. The skilled artisan will appreciate that steps 506-514 regarding the receipt of operational and feature data, as set forth above, are capable of being performed in any order, and the association of one data type to a given reference number is for example purposes only. Thus, it will be understood by those skilled in the art that feature data is capable of being received prior to operational data, identification data prior to historic usage data, or the like, without departing from the scope of the subject application.

Flow then proceeds to step 516, whereupon a determination is made whether a utilization report is to be made to an associated administrator. The skilled artisan will appreciate that the administrator, via the user interface 106, the user device 114, or the like, is capable of providing instructions to the monitoring component of the controller 108 corresponding to when to report operational and feature data to the administrator. Suitable instructions include, for example and without limitation, restrictions as to the time, date, document processing device 104 activity, or the like, so as to have minimal impact on the operations of the document processing device 104. Upon a determination at step 516 that no report is required, flow returns to step 504, whereupon monitoring of the operations of the document processing device 104 continues as set forth above.

When it is determined by the controller 108 at step 516 that a report is necessary, flow proceeds to step 518, whereupon the operational data is compared to the feature data. At step 520, utilization data is generated by the controller 108 in accordance with the result of the comparison of the operational data with the feature data. It will be understood by those skilled in the art that the utilization data also includes underutilized capability information corresponding to those capabilities, features, resources, and the like, which are underutilized, based upon the operational data and the feature data. An electronic document is then output by the document processing device 104 at step 522 and communicated, at step 524, to the administrator at the user device 114 via the computer network 102.

In accordance with one embodiment of the subject application, the electronic document includes the generated utilization data, as well as recommendations, based upon the underutilized capability information, as to which of the features, capabilities, resources, or the like, should be modified by the administrator so as to improve the performance of the associated document processing device 104. For example and without limitation, the controller 108 or other suitable component associated with the document processing device 104 and implementing the monitoring component, analyzes the received operational data and feature data to determine which features and/or resources are underutilized. These features and/or resources are then noted in the report to the administrator as those features and/or resources whose modification will result in an increase in the performance of document processing operations by the document processing device 104.

Thus, as will be appreciated by those skilled in the art, the administrator, via the user device 114, receives the electronic document, such as a utilization report, and is provided with the opportunity to modify features, capabilities, resource utilization rights, and the like, corresponding to the document processing device 104. A determination is then made at step 526 whether any adjustment data has been received by the controller 108 from the administrator. When no adjustment data has been received, operations return to step 504, whereupon the controller 108 or other suitable component associated with the document processing device 104 continues to monitor operational and feature data corresponding to the device 104.

When adjustment data has been received by the controller 108 from the administrator, flow proceeds to step 528, whereupon the adjustment data is analyzed. A determination is then made at step 530 in accordance with the analysis of the received adjustment data whether one or more capabilities of the document processing device 104 are to be disabled. The skilled artisan will appreciate that such a determination is based upon selections or modifications made by the administrator to disable unused capabilities, resource intensive operations, or the like. A positive determination at step 530 prompts the selective disabling of the identified capabilities of the document processing device 104 in accordance with the received adjustment data at step 532. Flow then proceeds to step 534, whereupon device resources are reallocated in accordance with the received adjustment data. With a negative determination at step 530 flow proceeds directly to step 534, whereupon resources associated with the document processing device 104 are then reallocated in accordance with the received adjustment data. Once the resources associated with the document processing device 104 are reallocated, flow returns to step 504 and proceeds further in the manner already discussed in detail above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for securing of document processing devices in accordance with use patterns comprising:
means adapted for receiving operational data associated with historic operation of an associated document processing device;
means adapted for receiving feature data corresponding to available capabilities of the associated document processing device;
generator means adapted for generating utilization data in accordance with received operational data and received feature data, wherein the utilization data includes data representative of underutilized capabilities of the document processing device; and
output means adapted for outputting an electronic document inclusive of generated utilization data.

2. The system of claim 1 further comprising:
means adapted for receiving the operational data inclusive of identification data corresponding to identities of each of a plurality of users of the document processing device, which identification data is associated with operational data corresponding to a respective user; and wherein
the generator means includes means adapted for generating utilization data in accordance with a comparison of operational data and feature data.

3. The system of claim 2 wherein operational data includes data corresponding to resource utilization of the associated document processing device and wherein feature data includes data corresponding to available resources of the document processing device such that the generator means further includes means adapted for generating utilization data in accordance with comparison thereof.

4. The system of claim 3 further comprising means adapted for receiving adjustment data representative of a reallocation of resources of the associated document processing device in accordance with generated utilization data.

5. The system of claim 1 further comprising means adapted for selectively disabling capabilities of the associated document processing device in accordance with generated utilization data.

6. The system of claim 1 wherein the output means includes means adapted for communicating the electronic document to an associated administrator.

7. A method for securing of document processing devices in accordance with use patterns comprising the steps of:
receiving operational data associated with historic operation of an associated document processing device;
receiving feature data corresponding to available capabilities of the associated document processing device;
generating utilization data in accordance with received operational data and received feature data, wherein the utilization data includes data representative of underutilized capabilities of the document processing device; and
outputting an electronic document inclusive of generated utilization data.

8. The method of claim 7 further comprising the steps of:
receiving the operational data inclusive of identification data corresponding to identities of each of a plurality of users of the document processing device, which identification data is associated with operational data corresponding to a respective user; and wherein
the step of generating utilization data is in accordance with a comparison of operational data and feature data.

9. The method of claim 8 wherein operational data includes data corresponding to resource utilization of the associated document processing device and wherein feature data includes data corresponding to available resources of the document processing device such that the step of generating utilization data is in accordance with comparison thereof.

10. The method of claim 9 further comprising the step of receiving adjustment data representative of a reallocation of resources of the associated document processing device in accordance with generated utilization data.

11. The method of claim 7 further comprising the step of selectively disabling capabilities of the associated document processing device in accordance with generated utilization data.

12. The method of claim 7 further comprising the step of communicating the electronic document to an associated administrator.

13. A computer-implemented method for securing of document processing devices in accordance with use patterns comprising the steps of:
receiving operational data associated with historic operation of an associated document processing device;
receiving feature data corresponding to available capabilities of the associated document processing device;
generating utilization data in accordance with received operational data and received feature data, wherein the utilization data includes data representative of underutilized capabilities of the document processing device; and
outputting an electronic document inclusive of generated utilization data.

14. The computer-implemented method of claim 13 further comprising the steps of:
receiving the operational data inclusive of identification data corresponding to identities of each of a plurality of users of the document processing device, which identification data is associated with operational data corresponding to a respective user; and wherein
the step of generating utilization data is in accordance with a comparison of operational data and feature data.

15. The computer-implemented method of claim 14 wherein operational data includes data corresponding to resource utilization of the associated document processing device and wherein feature data includes data corresponding to available resources of the document processing device such that the step of generating utilization data is in accordance with comparison thereof.

16. The computer-implemented method of claim 15 further comprising the step of receiving adjustment data representative of a reallocation of resources of the associated document processing device in accordance with generated utilization data.

17. The computer-implemented method of claim 13 further comprising the step of selectively disabling capabilities of the associated document processing device in accordance with generated utilization data.

18. The computer-implemented method of claim 13 further comprising the step of communicating the electronic document to an associated administrator.
